(19) United States
(12) Patent Application Publication
(10) Pub. No.: US 2007/0096487 A1
(43) Pub. Date: May 3, 2007

(54) Cover device for a cargo space of a motor vehicle

(76) Inventor: Thomas Woerner, Sindelfingen (DE)

Correspondence Address: FLYNN THIEL BOUTELL & TANIS, P.C., 2026 RAMBLING ROAD, KALAMAZOO, MI, 49008-1631, US

(21) Appl. No.: 11/546,085

(22) Filed: Oct. 11, 2006

(30) Foreign Application Priority Data
Oct. 13, 2005 (DE) 102005049999.6

(51) Int. Cl. B60R 7/00

(52) U.S. Cl. 296/37.1; 296/37.16

(57) ABSTRACT

1. Cover device for a cargo space of a motor vehicle. 2.1. A cover device is known for a cargo space of a motor vehicle having a flexible flat structure which is held in such a way that it can be wound onto and unwound from a winding shaft and which is provided at its front end in the pulling out direction with a dimensionally stable profiled part which is secured in receptacles on the vehicle in an approximately horizontally pulled-out protective position of the flat structure, said receptacles being arranged on opposite lateral boundaries of the cargo space and with profile guides which adjoin the receptacles and extend along the lateral boundaries of the cargo spaces as far as a roof region of the cargo space, in which lateral boundaries the. profiled part can be moved in a sliding or rolling fashion together with the flat structure for movement between the protective position and a comfort position. 2.2 According to the invention, at least one securing means for temporarily fixing the profiled part is assigned to the profile guides and is arranged in an upper end region of the sliding guides. 2.3. Use for passenger cars. `

The invention relates to a cover device for a cargo space of a motor vehicle having a flexible flat structure which is held in such a way that it can be wound onto and unwound from a winding shaft and which is provided at its front end in the pulling out direction with a dimensionally stable profiled part which is secured in receptacles on the vehicle in an approximately horizontally pulled-out protective position of the flat structure, said receptacles being arranged on opposite lateral boundaries of the cargo space and with profile guides which adjoin the receptacles and extend along the lateral boundaries of the cargo space as far as a roof region of the cargo space, in which lateral boundaries the profiled part can be moved in a sliding or rolling fashion together with the flat structure for movement between the protective position and a comfort position.

In estate cars it is generally known to provide a cargo space cover in a rear-side cargo space. The cargo space cover has a flexible flat structure which is held in such a way that it can be wound onto and unwound from a winding shaft which is mounted fixed to the vehicle.

A dimensionally stable profiled part, which is also referred to as a contour part, is arranged at a front end of the flexible flat structure in the pulling out direction. The dimensionally stable profiled part has a guide pin at each of its sides lying opposite one another, said guide pins being releasably engaged in vehicle-mounted holders in the pulled-out protective position in which the cargo space cover covers the cargo space in an approximately horizontal direction. The vehicle-mounted holders are provided in a rear region of the cargo space on opposite lateral boundaries of the cargo space, in particular in the region of sidewalls lying opposite one another. The vehicle-mounted holders are adjoined by sliding guides which extend obliquely upwards in the direction of an inner roof lining and in which the profiled part can be moved upwards in order to transfer it from the pulled-out protective position into a comfort position.

The object of the invention is to provide a cover device of the type mentioned at the beginning which has a function which is improved compared to the prior art.

This object is achieved in that at least one securing means for temporarily fixing the profiled part is assigned to the profile guides and is arranged in an upper end region of the sliding guides. The securing means have the purpose of locking the profiled part, and thus also the flat structure, in the upwardly moved comfort position. This can prevent the profiled part from unintentionally sliding downwards again in the profile guides. The solution according to the invention is particularly advantageous for profile guides which are oriented in a relatively acute angle and in which a restoring force of a winding spring is not sufficient to secure the profiled part in the comfort position in the profile guides. The solution according to the invention can thus be used in particular for embodiments in which the force ratio between the winding on force of a winding drive, in particular of the winding spring, and the angle of inclination of the sliding guides or of the profile guides cannot bring about self locking for the profiled part.

In one refinement of the invention, the at least one securing means can be transferred into a release position as a function of the load. The profiled part can be moved in the profile guides in this release position.

In a further refinement of the invention, positive guiding means are provided in the upper end region of the profile guides, and they align the profiled part in a parked position which is moved towards the roof region relative to a normal guide position. The normal guide position is the position in which the profiled part is oriented during its transfer between the protective position and the comfort position. The parked position corresponds essentially to the comfort position with the difference that the additional movement of the profiled part towards the roof region is carried out. The profiled part is preferably pivoted in its comfort position towards the roof region so that the profiled part is transferred into the parked position by means of a pivoting movement. It is also possible to move the profiled part towards the inner roof lining even before the comfort position is reached. An advantage of this embodiment is that the dimensionally stable profiled part which is relatively large in area cannot hang downwards in the comfort position as a result of its own weight and thus adversely affect the capacity of the cargo space but rather is moved towards the inner roof lining into a space-saving position. The loading and unloading of the cargo space is facilitated further as a result of this.

In a further refinement of the invention, the securing means are of mechanical design and connect in a frictionally or positively locking fashion. Here, in particular bolt elements or latch elements or else clamping elements can be used. Corresponding bolt elements, clamp elements or latch elements preferably have spring force applied to them in order to permit the load-dependent release of the profiled part from the comfort position in a particularly simple way.

In a further refinement of the invention, the securing means act in a contactless fashion. In this embodiment, the securing means preferably build up a magnetic field which can be switched electrically or is maintained by means of permanent magnets. In the latter case, the magnetic force is bounded in such a way that it becomes possible to release the profiled part from the comfort position by grasping the profiled part and applying manual force.

In a further refinement of the invention, the profiled part is provided on its opposite sides with guide elements which are guided in the profile guides and form a guide axis which extends transversly with respect to the direction of movement and runs at a distance from a center of gravity of the profiled part, and the guide elements are assigned support means which hold the profiled part oriented in a defined guide position over its movement path in the sliding guides counter to its gravitational force. This is an advantageous refinement of the positive guiding means for transferring the profiled part into the parked position. The profiled part is advantageously already moved into a position in which it is raised counter to its gravitational force by the support means over the entire length of its movement path between the protective position and the comfort position so that reaching the comfort position inevitably also already includes reaching the parked position. The support means can be separate from the guide elements or connected to them in one piece.

In a further refinement of the invention, the positive guiding means comprise mechanical support means which exert a torque on the profiled part towards the inner roof lining during the transfer of the profiled part into the parked position. This brings about the desired transfer of the profiled part into the space-saving parked position with a mechanical means.

In a further refinement of the invention, the guide elements are of rotationally non-symmetrical design relative to a longitudinal axis of the profiled part. This permits the profiled part to be guided in the profile guides in a supported fashion if the profile guides themselves are also correspondingly adapted to the design of the guide elements. The guide elements are thus embodied in particular as sliding blocks or slide blocks for the profile guides.

Further advantages and features of the invention emerge from the claims and from the following description of preferred exemplary embodiments of the invention which are illustrated with reference to the drawings, in which:

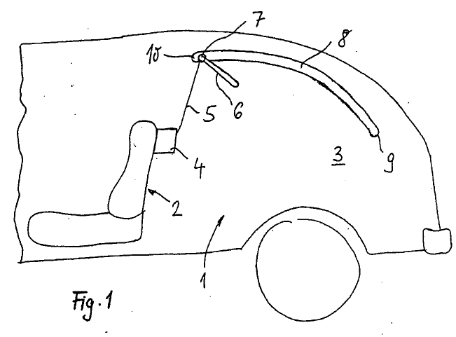

FIG. 1 is a schematic view of a detail of a motor vehicle which is provided with an embodiment of a cover device according to the invention,

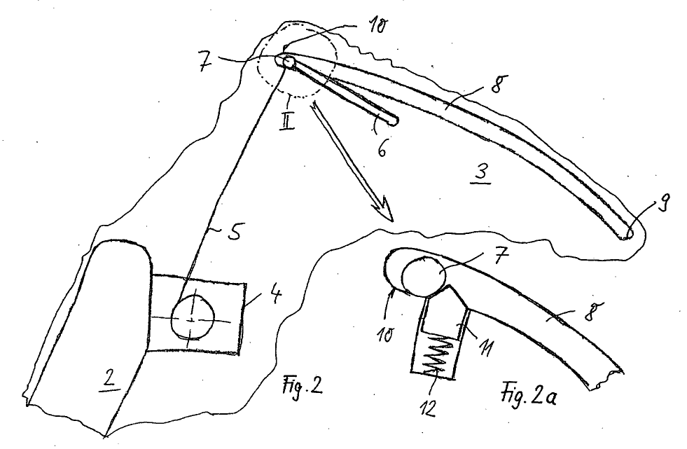

FIG. 2 is an enlarged schematic illustration of the cover device according to FIG. 1,

FIG. 2a shows an enlarged detail II of FIG. 2,

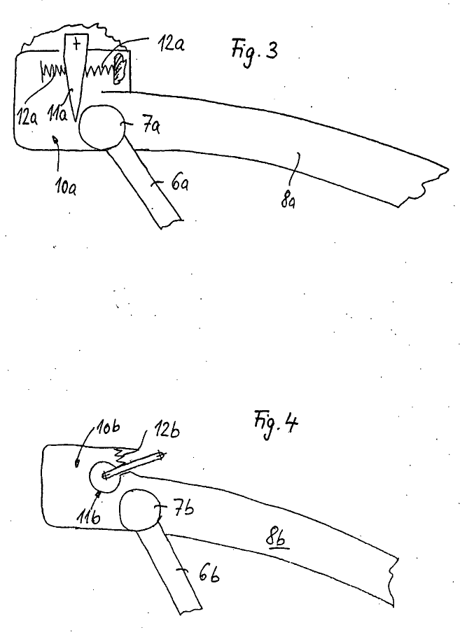

FIG. 3 shows a first variant for securing a profiled part of the cover device in a comfort position below an inner roof lining,

FIGS. 4 to 9 show further embodiments of mechanical securing means for the cover device according to FIG. 1, and

FIG. 10 is a magnetic variant of a securing means for the profiled part of the cover device.

A motor vehicle in the form of a passenger car with a cargo space 1 into which it is possible to see from the outside, in particular in the form of an estate car, of a van, of an SUV or the like, has a cover device which will be described in more detail below, in order to provide the cargo space 1 where necessary with a flat cover, approximately at the height of the sill of a vehicle. The cargo space 1 is bounded at the front by a backrest arrangement 2 of a seat bench. The cargo space 1 extends upwards in an open fashion as far as an inner roof lining of the vehicle body. In the downward direction the cargo space 1 is closed off in a way which is not illustrated in more detail by a movable vehicle body rear part, in particular a tailgate which pivots open in an upward direction. On its sides lying opposite one another the cargo space is bounded by lateral boundaries 3 which are defined by corresponding vehicle body sidewalls or associated vehicle passenger compartment paneling and corresponding side windows.

The cover device has a cartridge casing 4 which is arranged approximately at the height of the vehicle sill in the region of a rear side of the backrest arrangement 2. The cartridge casing 4 extends over the width of the cargo space 1 in the transverse direction of the vehicle. A winding shaft is rotatably mounted in the cartridge casing 4 and torque is applied to it in the winding on direction by a winding spring unit. A flat structure 5 is held in such a way that it can be wound onto and unwound from the winding shaft. The flexible flat structure 5 is provided at its front end region in the pulling out direction with a dimensionally stable profiled part 6 which forms a contour part. The profiled part 6 is embodied in the manner of a panel and extends at least over the entire width of the flexible flat structure 5. The profiled part 6 is arranged so as to be capable of sliding or rolling by means of guide elements 7 in lateral profile guides lying opposite one another. In the illustrated exemplary embodiment, the profile guides 8 extend in the lateral boundaries 3 of the cargo space 1. The profile guides 8 extend from a rear region of the cargo space 1 along corresponding lateral vehicle body pillars in the upward direction as far as a lateral roof frame area. The profile guides 8 are arranged above corresponding side windows here. The profile guides 8 are positioned fixed to the vehicle and are, in particular, permanently connected to the corresponding lateral vehicle body pillar sections. The profile guides 8 are embodied as guide rails in which in each case a guide element 7 of the profiled part 6 is guided so as to be capable of rolling or sliding. A lower, rear end 9 of the profile guides 8 defines a lower protective position for the flat structure 5 and the profiled part 6, in which position the flat structure 5 is pulled out approximately horizontally and extends over the length of the cargo space 1. The profiled part 6 is configured in such a way that in the approximately horizontal protective position it covers in an essentially flush fashion the gap area remaining between the extended flat structure 5 and an inner side of the tailgate. The profile guides 8 have a positive gradient in the upward direction starting from the lower protective position of the flat structure 5 and thus from the lower end 9, which positive gradient gradually reduces in the example. shown in FIG. 1 a far as an upper end 10 which defines an upper comfort position of the flexible flat structure 5 and of the profiled part 6, which position is illustrated in FIGS. 1 and 2.

In the schematically illustrated exemplary embodiment according to FIGS. 1 and 2 the positive gradient of the profile guides 8 changes. The advantages which are essential to the invention, such as are described below can be achieved in particular if the profile guides 6 also have an angle of inclination of more than 10° with respect to the horizontal in their upper region, i.e. in the region of the upper end 10.

In the normal driving mode the flexible flat structure 5 is in its protective position in which the profiled part 6 is also positioned in the lower end region 9 of the profile guides 6. In order to hold the flat structure 5 and the profiled part 6 in the lower protective position, a corresponding locking device is provided (in a way which is not illustrated in more detail). In order to permit improved access to the cargo space 1 for loading and unloading, the flexible flat structure 5 is transferred together with its profiled part 6 into an upper comfort position (illustrated in FIGS. 1 and 2) when the tailgate is opened. To do this, the locking device is easily released in the region of the lower end 9, as a result of which the profiled part 6 with its guide elements 7 is released for an upward movement in the profile guides 8. The drive for the movement of the profiled part 6 and of the guide element 7 is easily provided by the winding on force of the winding spring unit which acts on the winding shaft in the winding on direction within the cartridge casing 4. The locking device can be released manually or else in a positive fashion when the tailgate is opened.

In order to avoid a situation in which the profiled part 6 and the flexible flat structure 5 slide or roll back again in the direction of the lower protective position when there is a relatively large positive gradient of the profile guides 8 due to the intrinsic weight of the profiled part 6, the upper end region of the profile guides 8, which end in the end region 10, are assigned securing means 11, 12 (FIG. 2a) which secure the guide element 7 in the upper end region and thus in the upper comfort position of the profiled part 6. In the embodiment according to FIG. 2a, the securing means are each formed by a securing wedge 11 in each profile guide 8, said securing wedge 11 projecting from below into the profile guide 8 and being spring-loaded in the locking direction, i.e. in the upward direction, by a compression spring 12. In both profile guides 8 the same symmetrical arrangement of one securing wedge 11 in each case is provided. In order to move the profiled part 6 and thus the guide element 7 downwards again out of the protected comfort position, the profiled part 6 is easily grasped by a hand and pulled downwards. The restraining force of the securing wedges 11 is selected such that when the profiled part is pulled manually in the direction of the rear part of the vehicle the securing wedges 11 are pressed downwards counter to the compressive force of the respective compression spring 12, as a result of which the guide elements 7 can travel over the securing means.

In the embodiment according to FIG. 3, a securing latch 11a is provided instead of a securing wedge, said securing latch 11a being fixed to the vehicle above the end region 10a and being engaged in a pivotably movable fashion and being held in a position of equilibrium by two equalization springs 12a. The method of functioning is the same as in the embodiment according to FIG. 2a. The guide elements 7a press the securing latches 11a to the side in such a way that the corresponding guide element 7a can slide past the front edge of the respective securing latch 11a. The securing latch 11a is then pressed back into its position of equilibrium and locks the guide element 7a in the end region 10a.

The other variants which are described below also relate to similar methods of functioning. In the embodiment according to FIG. 4, a latch wheel 11b is provided which is also acted on by a compression spring. The more detailed method of functioning is clearly apparent in FIG. 4. The latch wheel 11b has a wheel which is rotatably mounted on a pivot lever and projects into the movement path of the guide element 7b in the locking position illustrated in FIG. 4 to such an extent that it forms a force-limited locking latch for the guide element 7b.

In the embodiment according to FIG. 5, instead of an engagement latch a wedge-like clamping element is provided which presses the guide element 7c of the profiled part into a pocket-like, upper receptacle of the end region 10c. Compression springs 12c also press the wedge element 11c into the profile guide 8c.

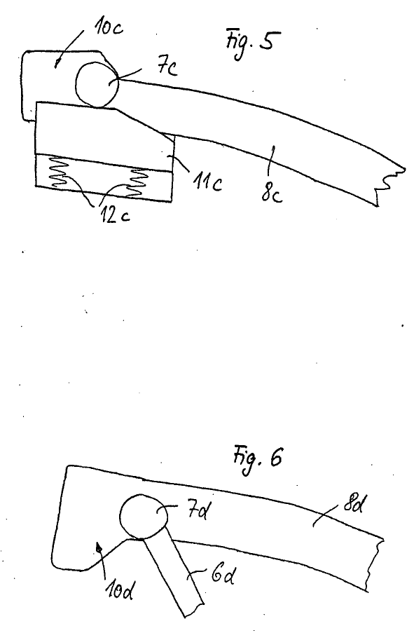

In the embodiment according to FIG. 6, a spring element is dispensed with. Here, in the region of the end 10d a downwardly protruding receptacle pocket is provided into which the guide elements 7d dip in a positive fashion in the end region of the profile guide 8d.

In all the exemplary embodiments described, each guide element 7 to 7h is embodied as a circular rolling or sliding element and thus as a rotationally symmetrical rolling or sliding element. According to an exemplary embodiment of the invention which is not illustrated, it is, however, also possible to make the guide elements rotationally non-symmetrical and to slide them in the profile guides in the manner of sliding blocks. In order to be able to bring about a low frictional resistance for the guide element in the embodiments according to FIGS. 2a to 10, the latter are preferably embodied as rolling elements.

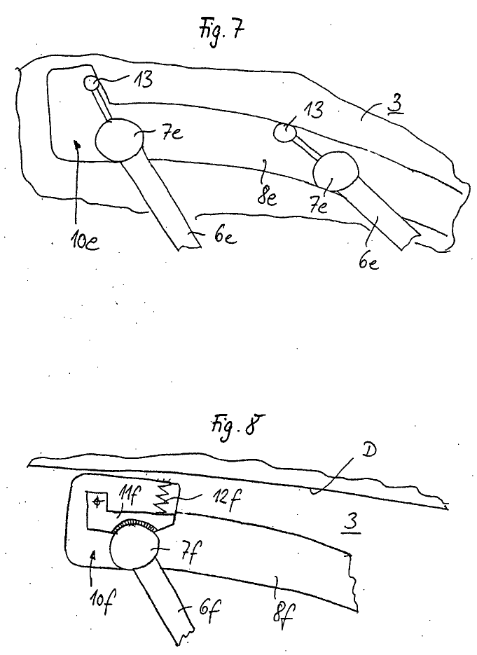

In the embodiment according to FIG. 7, the profiled part 6e is assigned additional support means 13 in the region of the guide element 7e, said support means 13 being embodied as a supporting extension which extends from the guide element 7 as a prolongation of the profiled part 6e on the opposite side. The supporting extension 13 can also have a rotationally symmetrical sliding or rolling element at its end. The supporting extension 13 serves to orient the profiled part 6e throughout the entire displacement process between the lower protective position and the upper comfort position in a defined position and thus lift up the intrinsic weight of the profiled part 6e. This is because the intrinsic weight of the profiled part 6e exerts a downward torque about the axis of rotation of the rotationally symmetrical guide element 7e, which torque is compensated by the supporting extension 13 which is supported on an upper rail section of the profile guide 8e. The supporting extension 13 serves simultaneously to secure the profiled part 6e in the comfort position, i.e. in the upper end region 10e of the profile guides 8e. To do this, an upwardly extending recess into which the supporting extension 13 dips and thus provides additional support for the profiled part 6e is provided in the upper end region 10e of each profile guide 8e.

In the embodiment according to FIG. 8, a locking latch 11f is provided in the upper end region 10f of the profile guides 8f and is provided with a receptacle region which is matched to the curvature of the guide element 7f. The receptacle region can additionally be provided with a frictional lining. The securing means 11f is embodied as a locking latch which is spring-loaded by a compression spring 12f.

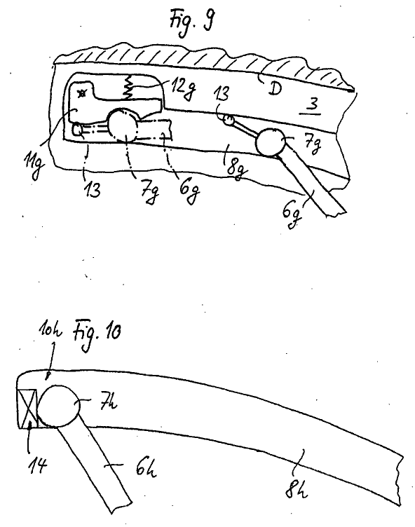

In the embodiment according to FIG. 9, a locking latch arrangement is provided similarly to FIG. 8. In addition, the profiled part 6e or the respective guide element 7g is provided with a supporting extension 13 such as has already been described in FIG. 7. In the embodiment according to FIG. 9, the supporting extension 13 serves to pivot the profiled part 6g in the comfort position into a parked position which is moved towards the inner roof lining D and to hold it in this parked position. To do this, the supporting extension 13 slides along the locking latch 11g. At the same time, the rolling guide element 7g is supported on the lower rail section of the profile guide 8g.

In the embodiment according to FIG. 10, the guide elements 7h are provided with a magnetic material and at least one magnetic element 14, which secures the respective guide element 7h and thus also the profiled part 6h in the comfort position, is provided as a securing means in the end region 10h.

1. Cover device for a cargo space of a motor vehicle having a flexible flat structure which is held in such a way that it can be wound onto and unwound from a winding shaft and which is provided at its front end in the pulling out direction with a dimensionally stable profiled part which is secured in receptacles on the vehicle in an approximately horizontally pulled-out protective position of the flat structure, said receptacles being arranged on opposite lateral boundaries of the cargo space and with profile guides which adjoin the receptacles and extend along the lateral boundaries of the cargo space as far as a roof region of the cargo space, in which lateral boundaries the profiled part can be moved in a sliding or rolling fashion together with the flat structure for movement between the protective position and a comfort position, characterized in that at least one securing means (11 to 11g, 12 to 12g, 14) for temporarily fixing the profiled part (6 to 6h) is assigned to the profile guides (8 to 8h) and is arranged in an upper end region of the profile guides (8 to 8h).

2. Cover device according to claim 1, characterized in that the at least one securing means can be transferred into a release position as a function of the load.

3. Cover device according to claim 1, characterized in that positive guiding means (13) are provided in particular in the upper end region of the profile guides and they align the profiled part (6g) in a parked position which is moved towards the roof region (D) relative to a normal guide position.

4. Cover device according to claim 1, characterized in that the securing means (11 to 11g, 12 to 12g) are of mechanical design and connect in a frictionally or positively locking fashion.

5. Cover device according to claim 1, characterized in that the securing means (14) act in a contactless fashion, in particular by building up a magnetic field.

6. Cover device according to claim 1, characterized in that the profiled part (6e) is provided on its opposite sides with guide elements (7e) which are guided in the profile guides (8e) and form a guide axis which extends transversly with respect to the direction of movement and runs at a distance from a center of gravity of the profiled part (6e), and in that the guide elements (7e) are assigned support means (13) which hold the profiled part (6e) oriented in a defined guide position over its movement path in the profile guides (8e) counter to its gravitational force.

7. Cover device according to claim 3, characterized in that the positive guiding means comprise mechanical support means (13) which exert a torque on the profiled part (6g) towards the inner roof lining (D) during the transfer of the profiled part (6e) into the parked position.

8. Cover device according to claim 6, characterized in that the guide elements are of rotationally non-symmetrical design relative to a longitudinal axis of the profiled part which runs in the transverse direction of the vehicle.
